(19) United States
(12) Patent Application Publication
(10) Pub. No.: US 2013/0290465 A1
(43) Pub. Date: Oct. 31, 2013

(54) SYSTEM AND METHOD FOR PROXY MEDIA CACHING

(71) Applicant: UNWIRED PLANET INC., Reno, NV (US)

(72) Inventors: Declan Harrison, Belfast (IE); Eoin McQuillan, Belfast (IE)

(21) Appl. No.: 13/855,932

(22) Filed: Apr. 3, 2013

Related U.S. Application Data
(60) Provisional application No. 61/620,315, filed on Apr. 4, 2012.

(51) Int. Cl. H04L 29/08

(52) U.S. Cl. CPC H04L 67/02
USPC 709/213

(57) ABSTRACT

Systems and methods for proxy media caching are disclosed. A method in accordance with an embodiment of the invention includes receiving at a proxy a response to a request for media content, generating a fingerprint from a sample of media content contained in the response, searching a cache using the fingerprint, and if a cache hit occurs, causing cached media content, which is associated with the cache hit, to be sent to the client device.

### CROSS-REFERENCE TO RELATED APPLICATION

This application is entitled to the benefit of provisional U.S. Patent Application Ser. No. 61/620,315, filed Apr. 4, 2012, which is incorporated herein by reference.

### BACKGROUND

Proxy media caching techniques typically use uniform resource locators (URLs) found in requests for media content to index and search media content in a cache. However, the same media content can be identified by multiple different URLs, which can cause the same media content to be stored multiple times in the same cache. For example, when different video files contain the same video content but are encoded in different formats (e.g., as a Flash video file, a Moving Picture Experts Group (MPEG) file, or a Windows Media Video (WMV) file), these video files are separately indexed and stored in the cache by their corresponding URLs. In addition, with the use of Content Delivery Networks (CDNs), a request for a specific media file may be translated into a different URL domain or path on each subsequent request. Consequently, conventional proxy media caching techniques often result in the same media content being stored as multiple different entries in the same proxy cache.

### SUMMARY

Systems and methods for proxy media caching are disclosed. A method for providing media content to a client device in accordance with an embodiment of the invention involves receiving at a proxy a response to a request for media content, generating a fingerprint from a sample of media content contained in the response, searching a cache using the fingerprint, and if a cache hit occurs, causing cached media content, which is associated with the cache hit, to be sent to the client device. This allows the cache to be organized according to fingerprints that are reflective of the actual media content, which simplifies cache organization and reduces the redundant caching of media content.

A method for providing media content to a client device in accordance with another embodiment of the invention involves receiving at a Hypertext Transfer Protocol (HTTP) proxy an HTTP response to an HTTP request for media content, generating a fingerprint from a sample of media content contained in the HTTP response, searching a cache using the fingerprint, and if a cache hit occurs, causing cached media content, which is associated with the cache hit, to be sent to the client device.

A proxy in accordance with an embodiment of the invention receives a response containing media content. The proxy includes a cache management module configured to generate a fingerprint from a sample of the received media content and to search a cache using the fingerprint. If a cache hit occurs, cached media content, which is associated with the cache hit, is sent to the client device.

A non-transitory computer readable medium in accordance with an embodiment of the invention stores program instructions executable by a processor, which when executed by the processor, perform the steps of receiving at a proxy a response to a request for media content from a client device, generating a fingerprint from a sample of media content contained in the response, searching a cache using the fingerprint, and if a cache hit occurs, causing cached media content, which is associated with the cache hit, to be sent to the client device.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a content delivery system in accordance with an embodiment of the invention.

FIGS. 2A and 2B illustrate an example of a caching operation that is implemented in the proxy depicted in FIG. 1.

FIGS. 3 and 4 illustrate two exemplary HTTP response messages.

FIG. 5 illustrates an embodiment of a fingerprint generation process.

FIGS. 6-8 depict three schematic diagrams of communications between a client device and an origin server through a proxy in accordance with an embodiment of the invention.

FIG. 9 illustrates a conventional cache lookup table.

FIG. 10 depicts a schematic diagram of a cache lookup table in accordance with an embodiment of the invention.

FIG. 11 is a process flow diagram of a method for providing media content to a client device in accordance with an embodiment of the invention.

FIG. 12 is a process flow diagram of a method for providing media content to a client device in accordance with another embodiment of the invention.

FIG. 13 depicts a computer that includes a processor, memory, and a communications interface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

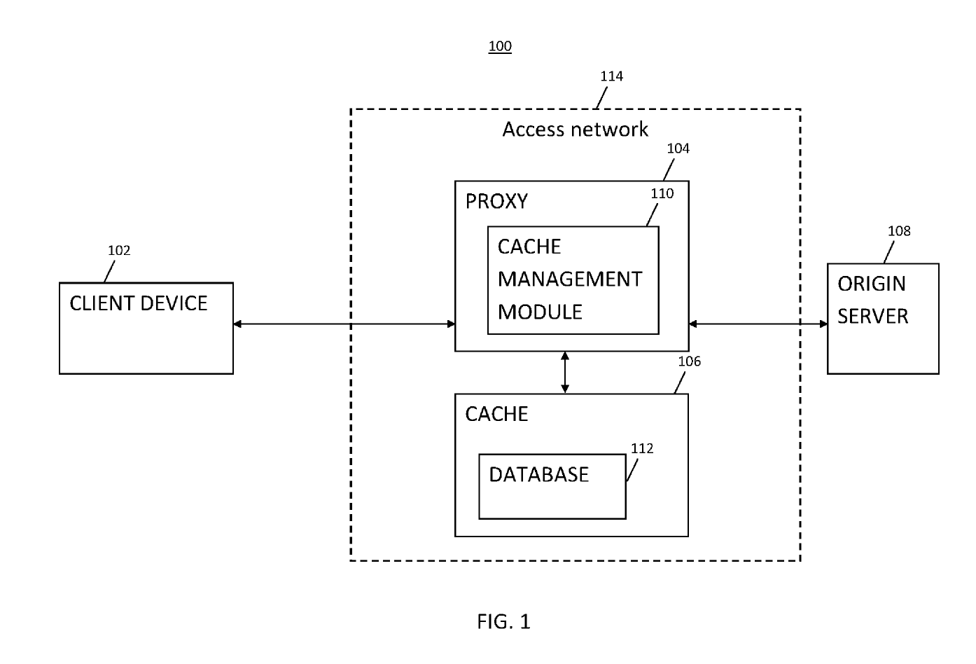

FIG. 1 depicts a content delivery system 100 in accordance with an embodiment of the invention. As described in more detail below, the content delivery system 100 includes a client device 102, a proxy 104, a cache 106, and an origin server 108. Although FIG. 1 is described with respect to one client device, one proxy, one cache, and one origin server, the description is not limited to a single client device, proxy, cache, and origin server.

The client device 102 is any networked device including, without limitation, a mobile phone, a smart phone, a personal digital assistant (PDA), a tablet, a set-top box, a video player, a laptop, or a personal computer (PC). In one embodiment, the client device is a wireless device that can support at least one of various different radio frequency (RF) communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that the present disclosure is not limited to the cited wireless communications protocols. In another embodiment, the client device is a wired device that communicates with the proxy 104 through a communication interface, such as analog modem, ISDN modem or terminal adapter, DSL modem, cable modem, Ethernet/IEEE 802.3 interface, or a combination thereof. In another embodiment, the client device is connected to the proxy via a combination of wireless and wired communication interfaces.

The proxy 104 is in the data communications path between the client device 102 and the origin server 108 and is implemented in, for example, a proxy server or gateway. In one embodiment, the proxy is a transparent proxy that passes requests and responses (e.g., HTTP requests and responses) between client devices such as the client device 102 and host servers such as the origin server 108 without modifying the requests and responses. A proxy that simply passes requests and responses is often referred to as a gateway or tunneling proxy. In another embodiment, the proxy is a non-transparent proxy that can modify requests and responses between client devices and host servers in order to provide additional services. For example, a non-transparent proxy may provide media caching services, group annotation services, media type transformation services, or protocol reduction services. In one embodiment, the proxy is an HTTP proxy that can parse HTTP requests and HTTP responses. In the embodiment depicted in FIG. 1, the proxy includes a cache management module 110 configured to manage the cache 106.

The proxy 104 is coupled to the cache 106, which may be located in the same server as the proxy or may be located in a physically separate computer system. The cache is a storage device and/or storage system that stores data. In the embodiment depicted in FIG. 1, the cache includes a database 112 configured to store cached content such as frequently requested video files from origin servers that host video content. In one embodiment, the proxy is part of a wireless service provider network and the client device 102 is a wireless device, such as a mobile phone, that is a recognized/authorized subscriber to the wireless service provider network.

In one embodiment, the proxy 104 and the cache 106 are part of an access network 114, which provides a communications interface for the client device 102 to access the Internet or an intranet. Typical access networks include wireless service provider networks (e.g., that offer 3G, 4G and/or WiFi access) and Internet Service Providers (ISPs, e.g., that offer dial-up, DSL, and cable modem access). A private enterprise network can also serve as the access network if client devices within the private enterprise network can access the Internet through the private enterprise network. In one embodiment, the access network is a wireless service provider network that provides a wireless communications interface for the client device. The wireless service provider network is accessible on a subscription basis (e.g., prepaid or post-paid) as is known in the field. In an embodiment, the wireless service provider network is a closed domain that is accessible only by a subscriber (e.g. a user of the user device) that is in good standing with the operator of the wireless service provider network. The wireless service provider network may include a radio access network (not shown) and an Internet gateway (not shown). The radio access network includes one or more base stations to facilitate communications among wireless devices that are within a communication range of the base stations. Each base station has at least one RF transceiver and the base stations communicate with the wireless devices using RF communication signals. The radio access network facilitates network communications among multiple wireless devices within the same wireless service provider network and between wireless devices in other wireless service provider networks and provides interfaces to facilitate communications with other entities, such as a Public Switched Telephone Network (PSTN), a Wide Area Network (WAN), the Internet, Internet servers, hosts, etc., which are outside of the wireless service provider network. In an embodiment, the wireless service provider network is operated by a single wireless service provider, such as, for example, AT&T, VERIZON, T-MOBILE, and SPRINT. The Internet gateway (not shown) of the access network provides a gateway for communications between the client device 102 and Internet-connected hosts and/or servers, which can also be referred to as the “cloud.” The Internet gateway may include a Serving General Packet Radio Service (GPRS) Support Node (SGSN) and a Gateway GPRS Support Node (GGSN). For example, the Internet gateway can be a Wireless Application Protocol (WAP) gateway that converts the WAP protocol used by the access network (such as a wireless service provider network) to the HTTP protocol used by the Internet. In an embodiment, the Internet gateway enables the user device to access multimedia content, such as HTML, compact HTML (cHTML), and extensible HTML (xHTML), which is stored on Internet-connected hosts and/or servers. In this way, the access network provides access to the Internet for its subscribers.

The origin server 108 can be any device or system that hosts digital content, which can be stored in various formats, such as video files, audio files, and/or text files. In one embodiment, the origin server is an Internet-connected host or server that hosts Internet accessible content elements. The origin server may be a web server that can be accessed via, for example, HTTP, Internet Message Access Protocol (IMAP), or File Transfer Protocol (FTP). A content element is any set of digital data suitable for transfer in a networked environment, such as video files, markup language files, scripting language files, music files, image files or any other type of resource that can be located and addressed through, for example, the Internet.

Conventional proxy networks for wireless carriers or CDNs typically cache multiple different versions of the same media content, which may include video content, audio content, image content or other types of content, (including different formats and/or different resolutions) to accommodate the configurations and needs of various client devices. For example, conventional URL-based proxy cache systems will store multiple different versions of the same video content because each different version of the video content is identified by a different URL. Using this approach, limited cache resources are often consumed by redundant media content. In accordance with an embodiment of the invention, content fingerprints generated from media content are used to index the media content in a cache and to search the cache so that cached media content can be identified regardless of what version of the media content is received at the proxy. For example, video fingerprints generated from video content are used to index the video content in a cache and to search the cache so that cached video content can be identified regardless of what version of the video content is received at the proxy. Accordingly, media fingerprint caching can reduce the redundant storage of media content (e.g., video content) at a proxy, can reduce the load on a proxy backhaul network, and can provide a better user experience for users of wireless carriers and CDNs. An embodiment of a video fingerprint caching technique is described in more detail below.

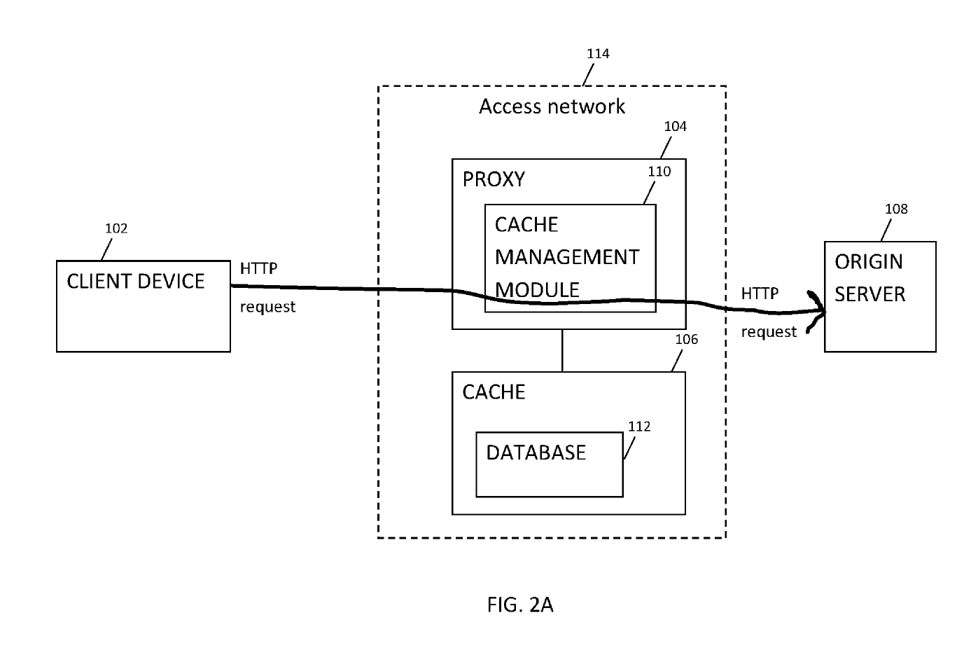

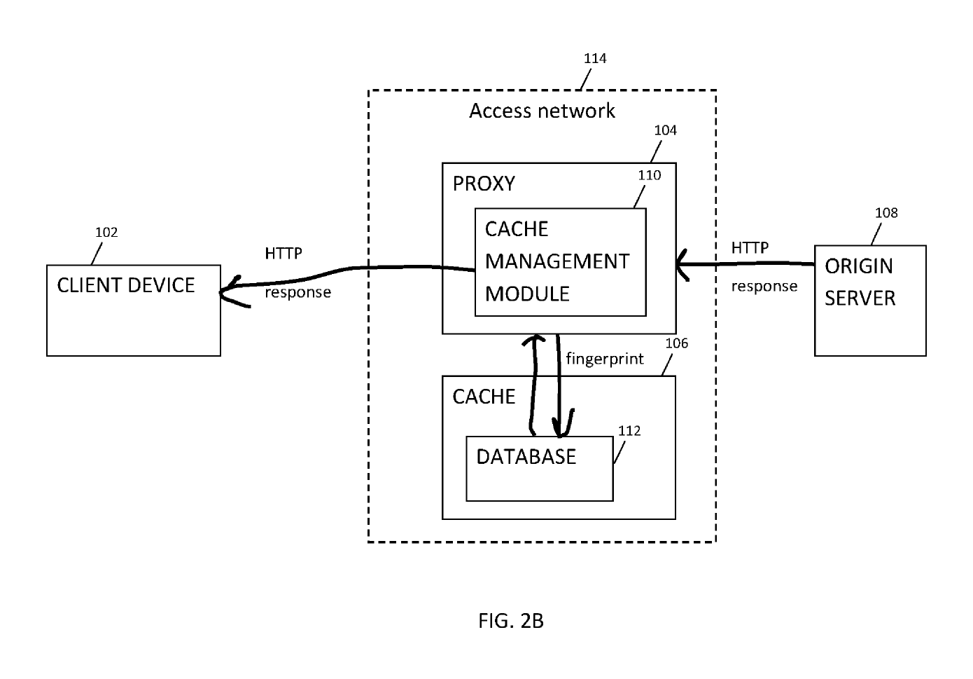

FIGS. 2A and 2B illustrate an example of a caching operation that is implemented in the proxy 104 depicted in FIG. 1 in a case where the media content is video content. Referring to FIG. 2A, the client device 102 sends an HTTP request (e.g., an HTTP request message) to the origin server 108 for video content. For example, the request is made by activating a link in a wireless device that corresponds to a desired video clip such as a particular sports highlight. Because the proxy is in the data communications path between the client device and the origin server, the proxy receives the HTTP request from the client device. The HTTP request is provided from the proxy to the origin server, either in its original form or in a modified form.

Referring now to FIG. 2B, in response to the received HTTP request, the origin server 108 returns an HTTP response (e.g., an HTTP response message). The HTTP response contains at least a portion of the video content that was requested by the client device 102. In an embodiment, the HTTP response is received at the proxy 104 via HTTP Adaptive Streaming, HTTP Dynamic Streaming, HTTP progressive download or another HTTP streaming protocol. In an embodiment, the HTTP request from the client device 102 and the HTTP response from the origin server are transmitted using Internet Protocol (IP) packets, as is known in the field of IP and TCP/IP communications. In an embodiment, the HTTP response message is carried in multiple IP packets. As illustrated in FIG. 2B, the HTTP response is received by the proxy.

Upon receiving the HTTP response, the proxy 104 determines if the HTTP response contains video content. For example, the proxy can check the content-type field of the response header. Once it is determined that the HTTP response contains video content, the cache management module 110 generates a video fingerprint from the video content and searches the cache 106 using the fingerprint. In an embodiment, the video fingerprint is an identifier that is generated from a sample of the video content that is carried in the HTTP response. In an embodiment, metadata related to the video content is used along with the video content sample to generate the video fingerprint. The video fingerprint is then used in a cache search operation to see if there is any cached video content that matches the fingerprint.

Depending on whether a cache hit/miss occurs, cached video content is sent to the client device. In addition, depending on whether a cache hit/miss occurs, video content contained in the HTTP response can be indexed by the fingerprint and stored in the cache 106. A cache hit occurs if the fingerprint matches an entry in the cache. For example, a cache hit occurs if the fingerprint matches a previously identified fingerprint in the cache. If a cache hit occurs, cached video content that is stored in the database 112 is sent to the client device 102. Cached video content can be sent to the client device via the cache management module 110 or through another communications path such as directly from the cache.

When a cache hit occurs and the cached video content and the requested video content have different formats, the cache management module 110 can send the cached video content to the client device 102 if the client device can support the format in which the cached video content is encoded. Alternatively, the cache management module 110 can dynamically re-multiplex or transcode the cached video content on the fly to a format that is supported by the client device or to the format specified in the HTTP request. If the cache management module 110 cannot dynamically re-multiplex the video content, the cache management module 110 can request that the origin server 108 return video content in a format that is supported by the client device. Alternatively, the cache management module 110 can request that the origin server return video content that is in the format specified in the HTTP request.

If a cache miss occurs, the video content in the received HTTP response can be sent to the client device 102 from the proxy 104. Additionally, if a cache miss occurs, a copy of the video content in the HTTP response can be stored in the cache and indexed by its fingerprint for future use. In an embodiment, additional criteria may be evaluated to determine whether or not to cache the video content. For example, a measure of the popularity of the video content may be used to determine whether or not to cache the video content.

In an embodiment, a TCP connection between the proxy 104 and the origin server 108 is established in order to communicate the video content between the proxy and the origin server. When a cache hit occurs and cached video content is served from the proxy, the cache management module 110 can terminate the TCP connection or cause the termination of the TCP connection. Terminating the TCP connection when the video content is served from the proxy helps to preserve connection resources at the proxy.

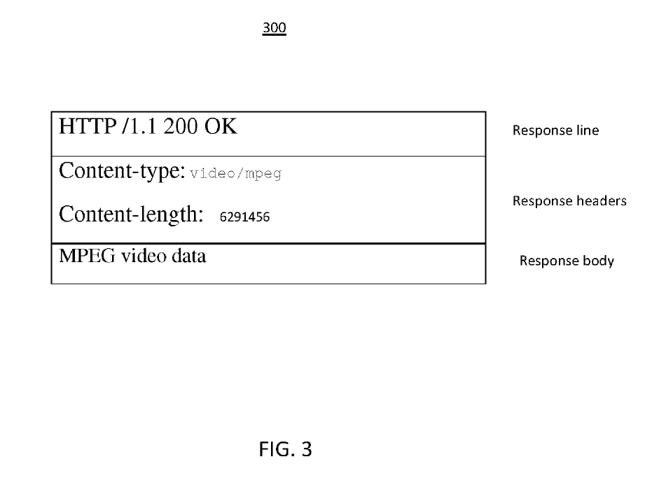

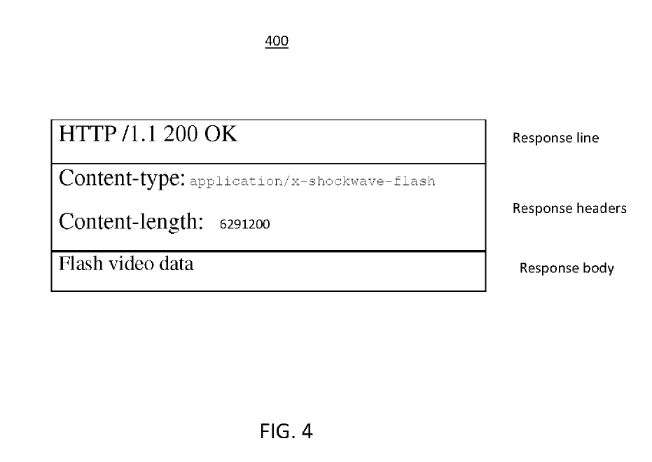

As described above, a video fingerprint is generated from video content that is contained in a response (e.g., an HTTP response) and is used to search the cache 106. Because multiple different versions of the same video content (e.g., different formats and/or different resolutions) can have matching video fingerprints, the video fingerprint technique allows the detection of cached video content even if a different version of the video content is received at the proxy 104. FIGS. 3 and 4 depict two HTTP response messages that contain the same video content. For example, the two HTTP response messages may contain two copies of the same sports highlight in different formats (e.g., one MPEG version and one Flash version). In another example, the two HTTP response messages may contain two copies of the same news broadcast in different formats.

FIG. 3 illustrates an HTTP response message 300 that includes MPEG formatted video content. As depicted in FIG. 3, the HTTP response message 300 includes a start line, which is also referred to as the response line, response headers, and a response body. The response line contains an HTTP version such as HTTP 1.1, and a status code such as “200 OK.” The response headers contain response content information such as the content-type and the content-length/duration. The content-type identifies the Internet media (e.g., Multipurpose Internet Mail Extensions (MIME)) type of the response body, which may be video, audio, image, or some other content type. For example, the content-type may be “video/mpeg,” which indicates that the response body contains video in “Moving Picture Experts Group” (MPEG) format, the content-type may be “text/html,” which indicates that the response body is an HTML document, the content-type may be “text/plain,” which indicates the response body is a document in plain text, the content-type may be “image/gif,” which indicates that the response body is an image of type GIF, or the content-type may be “audio/x-wav,” which indicates that the response body contains WAV sound data. As shown in FIG. 3, the content-type is “video/mpeg,” which indicates that the response body contains video in MPEG format. The content-length identifies the length of the response body in bytes. In the HTTP response message 300 of FIG. 3, the content-length is 6291456 bytes.

FIG. 4 illustrates an HTTP response message 400 that includes Flash formatted video content. In particular, the content type of the HTTP response message 400 is “application/x-shockwave-flash” as opposed to “video/mpeg” as shown in FIG. 3. In addition, the content-length of the Flash video data in FIG. 4 is 6291200 bytes, which is slightly different from the content-length of the MPEG video data in FIG. 3. Although video data in the HTTP response messages 300 and 400 have different formats and different lengths, video data in the HTTP response messages 300 and 400 (e.g., the same sports highlight) can have matching video fingerprints. Because matching video fingerprints are generated from the two different HTTP responses, a single copy of the particular video (e.g., the same sports highlight) can be stored in the proxy cache and indexed by its fingerprint.

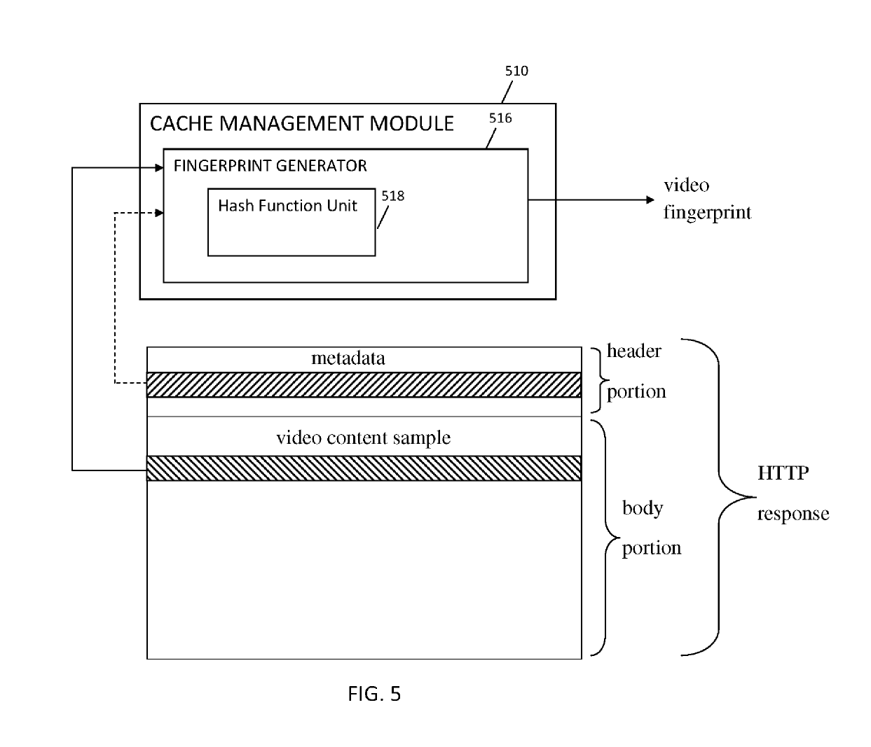

FIG. 5 illustrates an embodiment of the fingerprint generation process. In particular, FIG. 5 depicts an embodiment of the cache management module 110 and portions of an HTTP response that are used to generate a video fingerprint. As described in more detail below, the cache management module 510 includes a fingerprint generator 516, which in turn includes a hash function unit 518. The cache management module 510 performs functions similar to or the same as the cache management module 110.

In operation, the fingerprint generator 516 receives a sample of the video content in the HTTP response. Examples of the video content include, without limitation, a Flash video (e.g., FLV) file, a MPEG file, and a WMV file. The fingerprint generator generates the fingerprint from the sample of the video content, such as a sample of an encoded video frame of the video content, which is carried in the body portion of the HTTP response. In an example, the video fingerprint is a string of data, such as a hexadecimal string, that is used as a key to index video content in the cache 106 and to perform cache lookups. The sample of the video content may be a sample of at least one encoded video frame of the video content. For example, the sample of the video content may include one or more selected video frames of the video content. In an embodiment, the fingerprint generator selects a configurable number of bytes (e.g., 100 k bytes) of compressed video frame data from the video content and generates the video fingerprint from the selected bytes. Compressed video frame data refers to raw video image data that has not been decoded into a displayable video image. Voice samples can be used in addition to video frame data to generate a video fingerprint. In an embodiment, the fingerprint generator selects a configurable number of bytes (e.g., 100 k bytes) of compressed video frame data and voice samples from the video content and generates the video fingerprint from the selected bytes. Although 100 k bytes of data is given as an example, the amount of video content included in the sample is configurable. In addition, the location from which the sample is obtained is configurable. The location from which the sample is obtained may be determined with respect to time, e.g., by a time stamp or a time offset (e.g., several milliseconds) from a time stamp, or with respect to a number of bytes, e.g., the first 100 k bytes of video content or 100 k bytes of video content starting from a known byte offset (e.g., 32 k bytes into the body portion of the HTTP response). In an embodiment, a configurable amount of video data sampled at a particular location of the returned video content (e.g., the first 100 k bytes of video content) is used to generate a video fingerprint. The generated video fingerprint is compared to an index of previously stored video fingerprints that were generated from received video content, which was sampled at the same location of each received video clip. For example, 100 k bytes of video data taken from the beginning (e.g., from a time stamp of zero) of a sports highlight clip carried in the response can be used to generated a video fingerprint. The generated video fingerprint is compared to an index of previously stored video fingerprints that were generated from 100 k bytes of video data that was taken from the beginning (e.g., from a time stamp of zero) of previously received video clips. In an embodiment, the samples that are used to generate video fingerprints are taken at the same location for each HTTP response that includes video content.

As illustrated in FIG. 5, the fingerprint generator may also use metadata in the header portion of the HTTP response along with the sample of the video content in the body portion of the HTTP response to generate the fingerprint. For example, the fingerprint generator generates the fingerprint from a sample of the video content in the body portion of the HTTP response and from the duration of the video content in the header portion of the HTTP response. In another example, the fingerprint generator generates the fingerprint from a sample of the video content in the body portion of the HTTP response and from an identifier of the codec that was used to encode the video content in the header portion of the HTTP response. Metadata can be used to ensure that video content is not matched only based on an initial frame of video content, thereby reducing the possibility of a content mismatch, e.g., a cache hit between two video files that contain different video scenes. The amount of metadata used to generate the video fingerprint is configurable. In an embodiment, the hash function unit 518 generates the fingerprint as a hash function of the video data sample and the metadata. In this embodiment, the video fingerprint is a hash of the combined hexadecimal values of the video data sample and the metadata. The hash function used for generating video fingerprints may be a collision resistant hash function, such as a Message-Digest 5 (md5) hash function. In an example, the video fingerprint is an md5 hash of the video data sample and the metadata. In an embodiment, the hash function returns a string of data, such as a hexadecimal string, that represents a video fingerprint. This hexadecimal string is used as a key to index video content in the cache and to perform cache lookups. In one embodiment, the size of the hexadecimal string is set to be below a predetermined threshold to enable a rapid cache search. Beside the information parameters mentioned above, additional information can also be used to generate the video fingerprint.

In an embodiment, instead of using metadata in the header portion of the HTTP response to generate a video fingerprint, metadata in the header portion of the HTTP response is used as an extra criterion for determining if there is a video content match. In this embodiment, the video fingerprint is generated from the sample of the video content in the body portion and not from metadata in the header portion. If the video fingerprint matches a previously indexed video fingerprint (e.g., identical hexadecimal strings), metadata in the header portion of the HTTP response can be compared with metadata in the cache that is associated with the previously indexed video fingerprint as an extra criterion to determine if a match is appropriate. If the difference between the metadata in the header portion of the HTTP response and the metadata in the cache is within an acceptable threshold, it is determined that cached video content matches the returned video content. For example, when the metadata is the value in the “content-length” field, a match may be appropriate if the length of the cached video content and the length of the received video content are within an acceptable threshold, e.g., within 5% of each other.

In an embodiment, a cache hit occurs if a video fingerprint matches an entry in the cache 106. For example, a video fingerprint matches a previously stored video fingerprint if the two video fingerprints have the identical digital value, e.g., identical hexadecimal string.

Content providers may store multiple different versions of the same video content (e.g., a sports highlight or a news broadcast) on their origin servers. The different versions are typically characterized by different formats and/or different resolutions that are provided to different client devices and/or different bandwidth environments, such as dial-up, DSL, cable modem access, 3G, 4G, WiFi, etc. Using a video fingerprint generated from video content to index video content in a cache and to search the cache allows the detection of cached video content regardless what version of the video content is received at the proxy 104. For example, using the video fingerprint technique, two different versions of the same video content, e.g., one formatted in MPEG and the other formatted in Flash, can produce matching video fingerprints. In contrast, a conventional URL-based proxy cache system will store multiple different versions of the same video content (e.g., different formats and/or different resolutions) because each different version of the video content is identified by a different URL. However, because different versions of the same video can produce matching fingerprints, a single copy of a particular video can be stored in the cache and indexed by its fingerprint. Subsequent cache searches with a matching video fingerprint will produce a cache hit even if the format of the returned video content does not match the format of the cached video content. If a different version of a particular video is needed, cached video can be transcoded on the fly and served to a client. Therefore, using a video fingerprint generated from video content to index video content in a cache and to search the cache can eliminate the need to store multiple different versions of the same video in a proxy cache. As a result, the video fingerprint technique can reduce cache volume at the proxy and thereby allow a wider variety of content to be stored in the cache 106. In addition, the video fingerprint technique can reduce the load on a proxy backhaul network by eliminating redundant downloads of videos. Furthermore, the video fingerprint technique can provide a better user experience to clients because more content can be served directly from the proxy cache.

Although FIG. 5 is described with respect to one fingerprint generator and one hash function unit, the description is not limited to a single fingerprint generator and hash function unit. The cache management module 510, the fingerprint generator 516, and/or the hash function unit 518 can be implemented in hardware and/or software stored in a non-transitory computer readable medium. In one embodiment, a non-transitory computer readable medium stores program instructions executable by a processor, which when executed by the processor, perform the functions of the cache management module, the fingerprint generator, and/or the hash function unit.

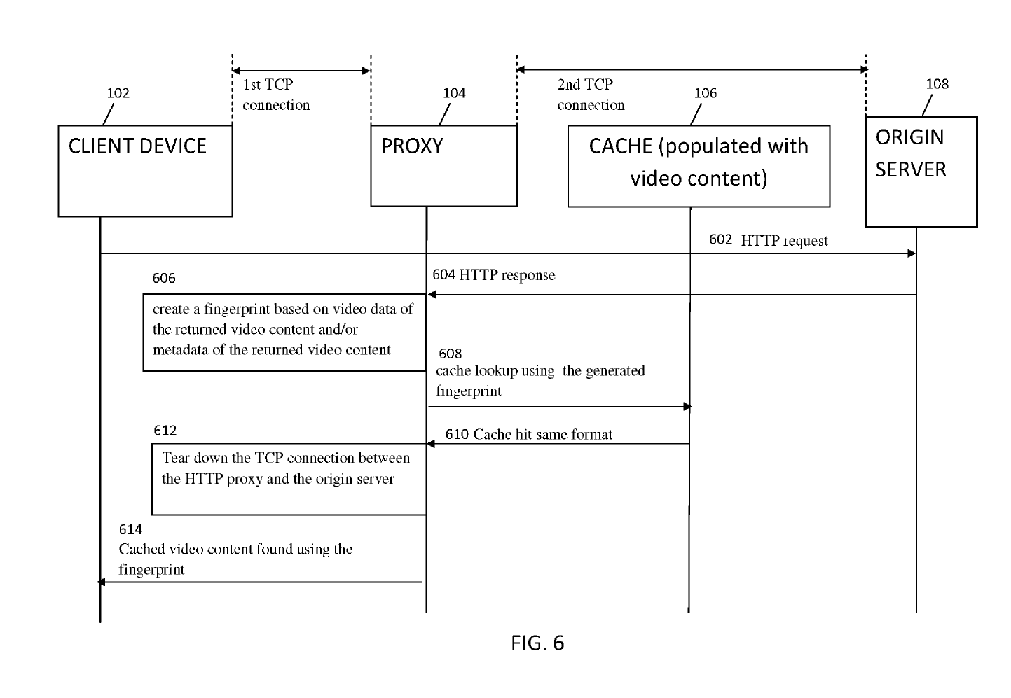

FIG. 6 depicts a schematic diagram of communications between the client device 102 and the origin server 108 through the proxy 104 in accordance with an embodiment of the invention. As shown in FIG. 6, at step 602, the client device sends an HTTP request to the origin server 108 through the proxy 104. When the HTTP request is for video content, the HTTP request may specify an HTTP streaming protocol, such as HTTP Adaptive Streaming, HTTP Dynamic Streaming, or HTTP progressive download, and a requested content name at the origin server. In the embodiment depicted in FIG. 6, communications between the client device and the proxy are carried out on a first TCP connection that is established between the client device and the proxy.

At step 604, the proxy 104 receives an HTTP response that the origin server 108 sends in response to the HTTP request. In this case, the HTTP response contains a header portion and a body portion, which includes the video content identified in the HTTP request. In the embodiment depicted in FIG. 6, communications between the proxy and the origin server are carried out on a second TCP connection that is established between the proxy and the origin server, which is separate from the first TCP connection.

At step 606, the proxy 104 creates a fingerprint based on video data of the returned video content or a combination of video data of the returned video content and metadata in the response, as described above with respect to FIGS. 1-5.

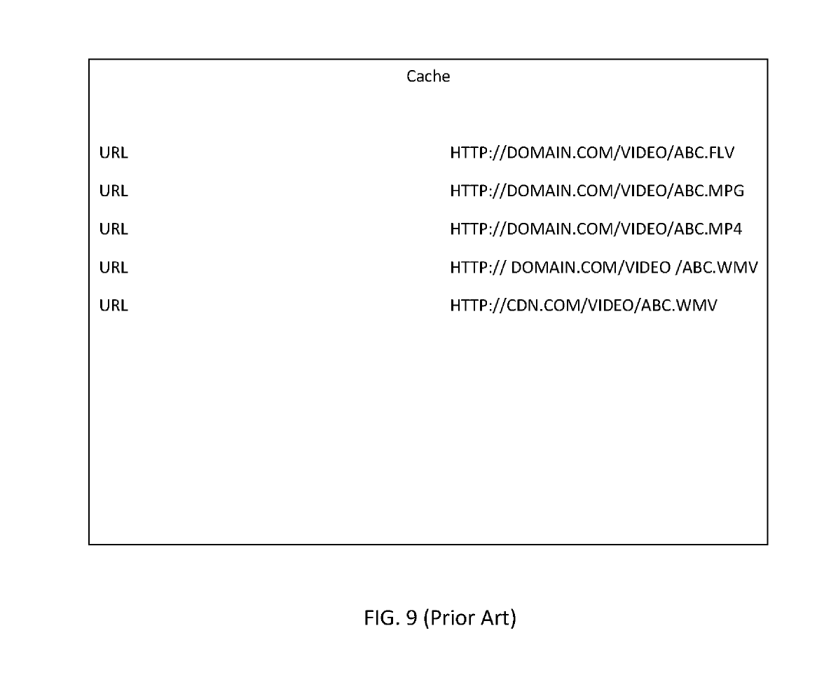

At step 608, the proxy 104 performs a cache lookup in the cache 106 using the generated fingerprint. The cache lookup is, for example, performed by comparing the generated fingerprint to an index of previously stored fingerprints, as will be described below in more detail with regard to FIG. 9.

After the cache lookup at step 608, the proxy 104 receives a response from the cache 106 indicating whether or not a matching cached video content has been found for the generated fingerprint. The cached video content may be encoded in the same format as the returned video content of the HTTP response or the cached video content may be encoded in a format that is different from the returned video content. A positive response indicates that a cache hit has occurred. If the response is positive, the HTTP response can be fulfilled from the proxy and the requested video content is sent from the proxy to the client device 102. A negative response indicates that a cache miss has occurred. If the response is negative, i.e., the video content element represented by the video fingerprint is not cached, the HTTP response is sent to the client device from the proxy. For example, the entire video content element is downloaded from the origin server and forwarded to the requesting client device. It may also be necessary to download a newer version of the requested video content even if the video content element is present in the cache if it is determined that the video content element in the cache is out of date. For example, the content element in the cache may have an expiration date that is used to determine the validity of the entry. In an embodiment, the downloaded video content element is placed into the cache.

As shown in FIG. 6, at step 610, the proxy 104 receives a cache hit message from the cache 106 that indicates that a cached video element has been found for the generated fingerprint in a format that is the same as the video content in the HTTP response. At step 612, the proxy terminates or tears down the second TCP connection, which is between the HTTP proxy and the origin server. At step 614, the proxy transmits cached video content found using the fingerprint to the client device 102.

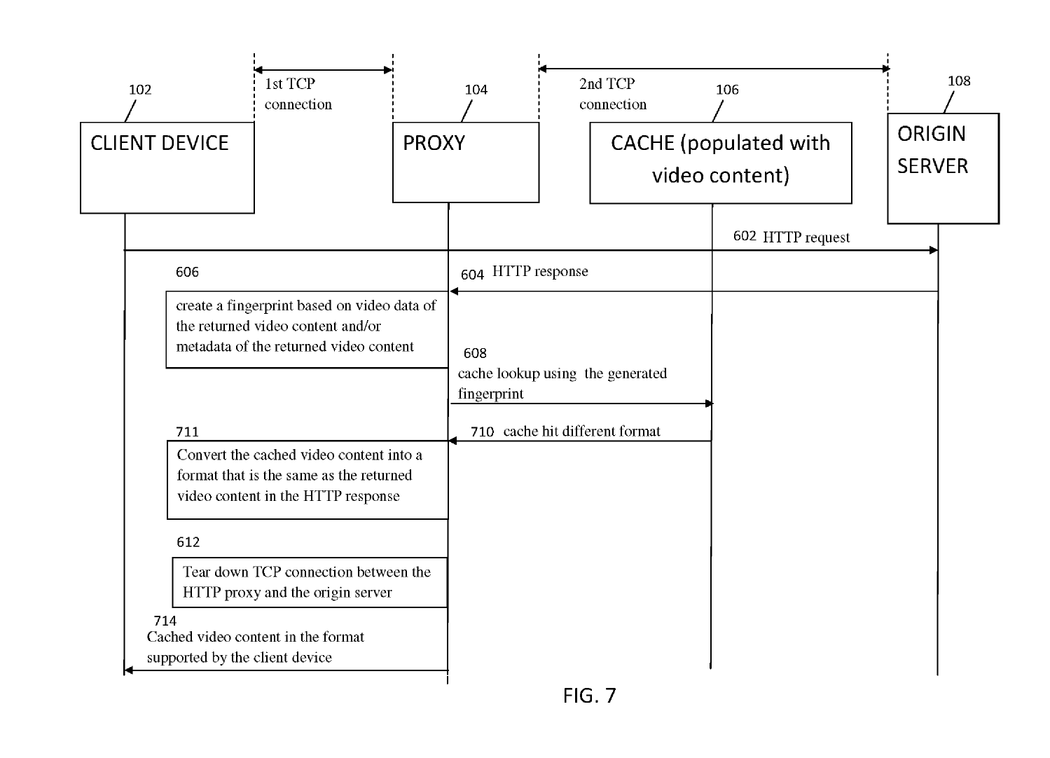

FIG. 7 depicts a schematic diagram of communications between the client device 102 and the origin server 108 through the proxy 104 in accordance with another embodiment of the invention. Steps 602, 604, 606, 608 of FIG. 7 are the same as steps 602, 604, 606, 608 of FIG. 6. The schematic diagram of FIG. 7 differs from the schematic diagram of FIG. 6 in that the proxy receives a cache hit message from the cache 106 (step 710) that indicates that a cached video element has been found for the generated fingerprint in a format that is different from the video content in the HTTP response. At step 711, the proxy converts the cached video content into the same format as the video content in the HTTP response. Converting the cached video content into the same format as the video in the HTTP response, which is presumably the format desired by the client device, allows the content to be provided directly from the cache even though the cache does not store the content in the same format. At step 612, the proxy terminates or tears down the second TCP connection, which is between the proxy and the origin server. At step 714, the proxy transmits the converted video content to the client device.

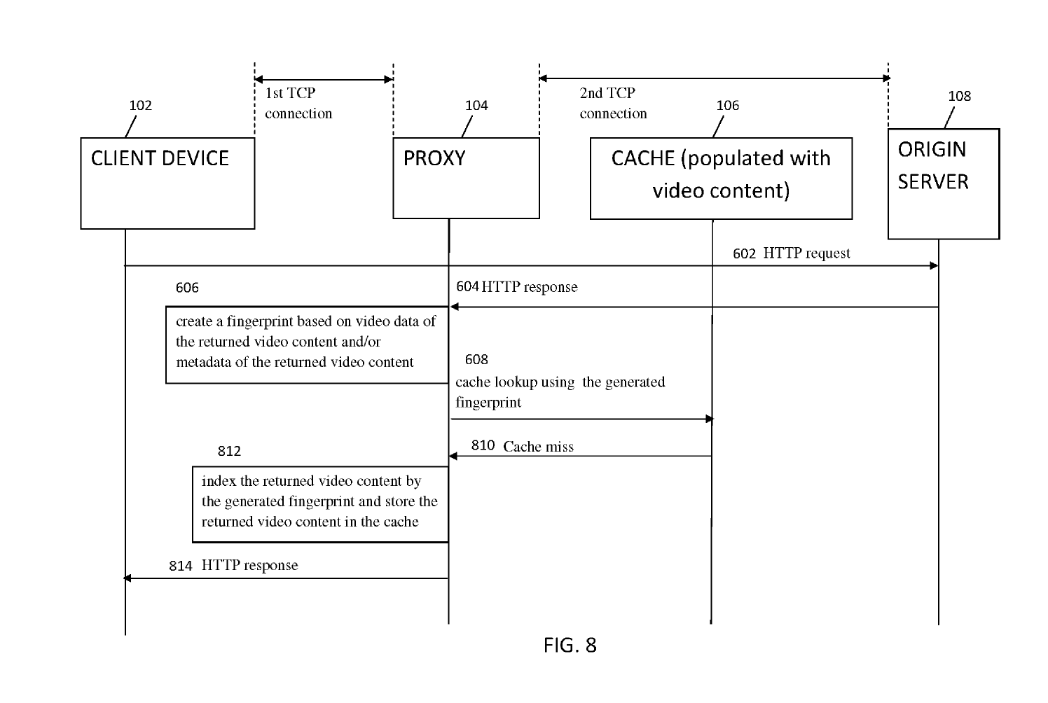

FIG. 8 depicts a schematic diagram of communications between the client device 102 and the origin server 108 through the proxy 104 in accordance with another embodiment of the invention. Steps 602, 604, 606, 608 of FIG. 8 are the same as steps 602, 604, 606, 608 of FIG. 6. The schematic diagram of FIG. 8 differs from the schematic diagram of FIG. 6 in that the proxy 104 receives a cache miss message (step 810) that indicates the video content element indexed by the fingerprint had not been previously cached. In the operations of FIG. 8, the TCP connection between the proxy and the origin server is not torn down as in the cases shown FIGS. 6 and 7. At step 812, the proxy indexes the returned video content by the corresponding fingerprint and stores the returned video content in the cache. In some embodiments, the returned video content is not added into the cache. At step 814, the proxy transmits the HTTP response to the client device via the first TCP connection, which is between the proxy and the client device.

FIG. 9 illustrates a conventional cache lookup table. In the cache lookup table of FIG. 9, a cache is organized according to the URLs of the video content elements. In the example of FIG. 9, video files ABC.FLV, ABC.MPG, ABC.MP4, and ABC.WMV are copies of the same video clip in four different streaming formats. Each of the video files ABC.FLV, ABC.MPG, and ABC.MP4 is located at a different web address (same domain name) and is identified by a different URL. In addition, the video file ABC.WMV is located at two different web addresses (different domain names) and is identified by two different URLs. Because the video files are identified by five different URLs, the video files are indexed in the cache by five different URLs. However, using the above-described fingerprint technique, the video files can be indexed by a single fingerprint, even although the video files are identified by five different URLs. Consequently, compared to traditional URL based cache indexing techniques, the fingerprint technique of the present invention simplifies cache organization, reduces cache lookup table size, and reduces the number of copies of the same video content that is cached.

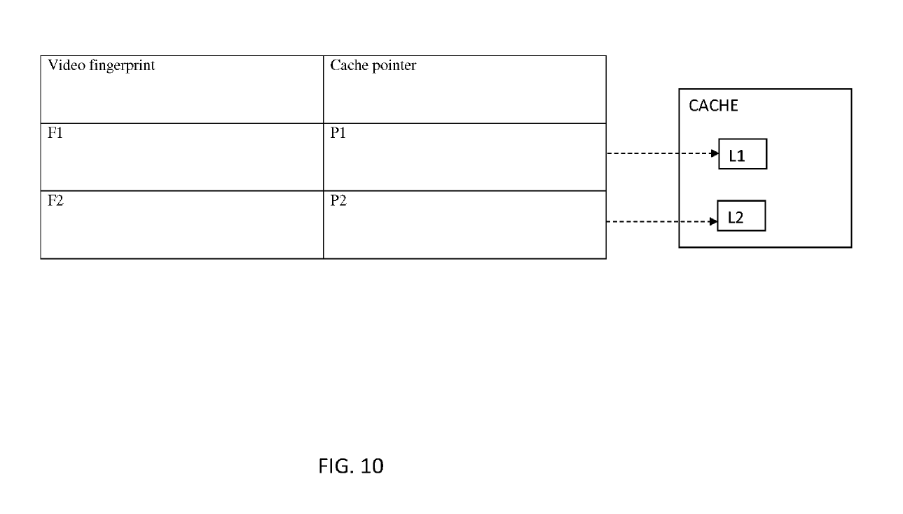

FIG. 10 depicts a schematic diagram of a cache lookup table in accordance with an embodiment of the invention. The cache lookup table is used during a cache lookup to determine whether a requested content element corresponding to a video fingerprint is present in the cache 106. The cache lookup table includes a column of video content fingerprints and a column of corresponding content pointers. The video fingerprints uniquely identify corresponding cached video content elements. The content pointers indicate the location in the cache at which the corresponding video content fingerprint is found. As shown in FIG. 10, video fingerprint “F1” corresponds to pointer “P1,” which points to cache location “L1” and video fingerprint “F2” corresponds to pointer “P2,” which points to cache location “L2.” Each time a particular video content fingerprint is created from returned video content in an HTTP response, the cache management module 110 or 510 does a cache lookup to determine whether or not that particular fingerprint is present in the column of fingerprints of the lookup table. The first time that a video content element is received at the cache management module, the video content element may be stored in the cache and the corresponding video fingerprint is assigned a pointer to the content element in the cache by the cache management module. Each subsequent time a video fingerprint is generated, and a table lookup reveals that the video fingerprint is the same as or within a threshold of an indexed video fingerprint, a content pointer assigned to the indexed video fingerprint is used to locate the cached content element. When a cache lookup reveals a miss, a new entry can be added to the cache lookup table and the video content element associated with a cache miss can be stored in the cache. A new entry, which includes the generated video fingerprint and assigned corresponding content pointer, is then added to the cache lookup table. The above examples of cache management are non-limiting and other techniques for cache management are possible.

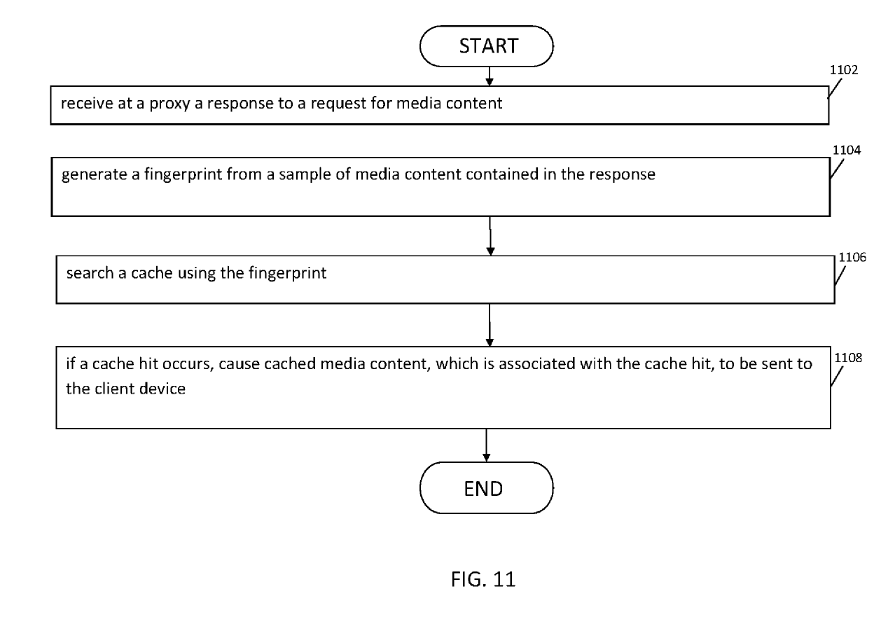

FIG. 11 is a process flow diagram of a method for providing media content to a client device in accordance with an embodiment of the invention. At block 1102, a response to a request for media content is received at a proxy. At block 1104, a fingerprint is generated from a sample of media content contained in the response. At block 1106, a cache is searched using the fingerprint. At block 1108, if a cache hit occurs, cached media content, which is associated with the cache hit, is caused to be sent to the client device.

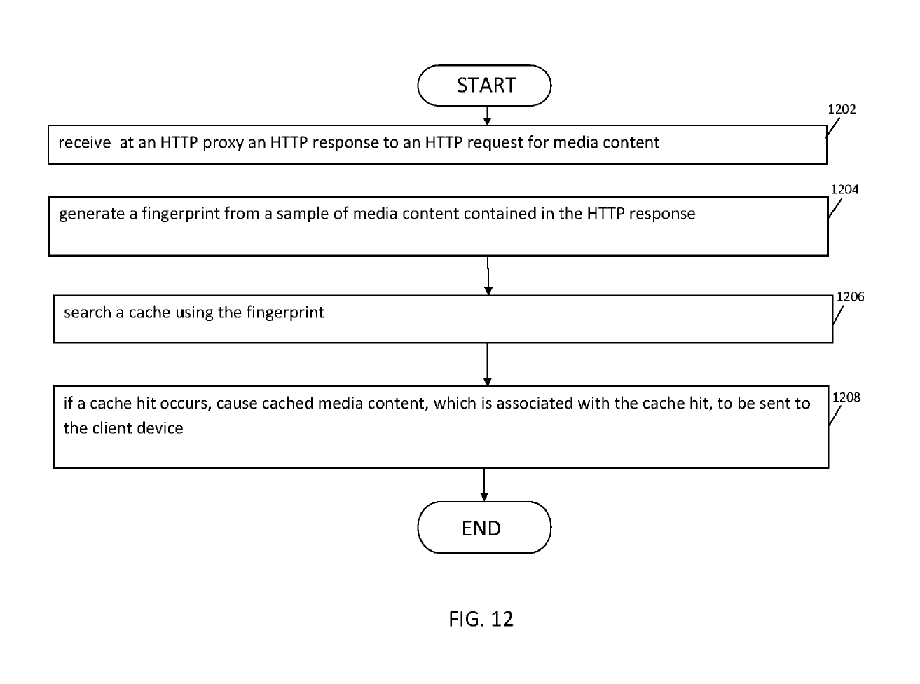

FIG. 12 is a process flow diagram of a method for providing media content to a client device in accordance with another embodiment of the invention. At block 1202, an HTTP response to an HTTP request for media content is received at an HTTP proxy. At block 1204, a fingerprint is generated from a sample of media content contained in the HTTP response. At block 1206, a cache is searched using the fingerprint. At block 1208, if a cache hit occurs, cached media content, which is associated with the cache hit, is caused to be sent to the client device.

Although some of the embodiments of invention are described with respect to video caching techniques, the above described video caching techniques can also be applied to other media types, including, for example, audio and/or image media. Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital versatile disk (DVD).

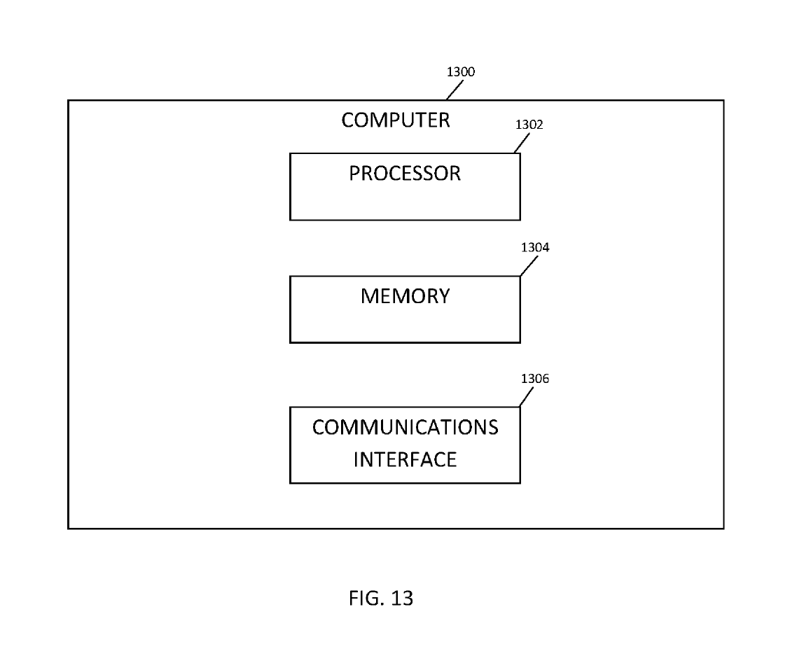

In an embodiment, the functionalities of the proxy 104, the cache management modules 110, 510, the fingerprint generator 516, and/or the hash function unit 518 are performed by a computer that executes computer readable instructions. FIG. 13 depicts a computer 1300 that includes a processor 1302, memory 1304, and a communications interface 1306. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is provisionally claimed is:

1. A method for providing media content to a client device, the method comprising:
receiving at a proxy a response to a request for media content;
generating a fingerprint from a sample of media content contained in the response;
searching a cache using the fingerprint; and
if a cache hit occurs, causing cached media content, which is associated with the cache hit, to be sent to the client device.

2. The method of claim 1, wherein the response is a Hypertext Transfer Protocol (HTTP) response, the request is an HTTP request, and the proxy is an HTTP proxy.

3. The method of claim 2, wherein the HTTP response is received at the HTTP proxy via HTTP Adaptive Streaming, HTTP Dynamic Streaming, or HTTP progressive download.

4. The method of claim 2 further comprising terminating a Transmission Control Protocol (TCP) connection associated with the HTTP response if a cache hit occurs.

5. The method of claim 1, wherein the fingerprint is generated from a sample of video content contained in the response, and wherein the cached media content comprises video content.

6. The method of claim 5, wherein the sample of video content comprises one or more selected video frames of the video content.

7. The method of claim 6, wherein the video content contained in the response comprises a Flash video file, a Moving Picture Experts Group (MPEG) file, or a Windows Media Video (WMV) file.

8. The method of claim 1, wherein the fingerprint is generated from metadata in the response and from the sample of media content contained in the response.

9. The method of claim 8, wherein the metadata includes metadata identifying a duration of the media content contained in the response or an identifier of the codec that was used to encode the media content contained in the response.

10. The method of claim 8, wherein the fingerprint is generated as a hash function of the metadata and the sample of media content.

11. The method of claim 1, wherein the client device is a wireless communications device.

12. The method of claim 11, wherein the response is a Hypertext Transfer Protocol (HTTP) response, the request is an HTTP request, the proxy is an HTTP proxy located in a wireless service provider network, and the wireless service provider network is located in a communications path between the wireless communications device and an origin server that stores a copy of the media content.

13. A proxy that receives a response containing media content, the response being generated in response to a request from a client device, the proxy comprising:
a cache management module configured to generate a fingerprint from a sample of the received media content and to search a cache using the fingerprint;
wherein if a cache hit occurs, cached media content, which is associated with the cache hit, is sent to the client device.

14. The proxy of claim 13, wherein the response is a Hypertext Transfer Protocol (HTTP) response, the request is an HTTP request, and the proxy is an HTTP proxy.

15. The proxy of claim 14, wherein the HTTP response is received at the HTTP proxy via HTTP Adaptive Streaming, HTTP Dynamic Streaming, or HTTP progressive download.

16. The proxy of claim 14, wherein the client device is a wireless communications device.

17. The proxy of claim 16, wherein the HTTP proxy is located in a wireless service provider network, and the wireless service provider network is located in a communications path between the wireless communications device and an origin server that stores a copy of the received media content.

18. The proxy of claim 14, wherein a Transmission Control Protocol (TCP) connection associated with the HTTP response is terminated if a cache hit occurs.

19. The proxy of claim 13, wherein the cache management module is further configured to generate the fingerprint from metadata in the response and from a sample of video content contained in the response, wherein the sample of video content comprises one or more selected video frames of the video content.

20. A non-transitory computer readable medium that stores program instructions executable by a processor, which when executed by the processor, perform the steps of:
receiving at a proxy a response to a request for media content from a client device;
generating a fingerprint from a sample of media content contained in the response;
searching a cache using the fingerprint; and
if a cache hit occurs, causing cached media content, which is associated with the cache hit, to be sent to the client device.
